(19) United States
(12) Patent Application Publication
(10) Pub. No.: US 2007/0153807 A1
(43) Pub. Date: Jul. 5, 2007

(54) Base-station aided resource sharing broadband access system, methods, and devices

(75) Inventors: Rene L. Cruz, La Jolla, CA (US); Huseyin Cahit Akin, San Diego, CA (US)

Correspondence Address: GREER, BURNS & CRAIN, 300 S WACKER DR, 25TH FLOOR, CHICAGO, IL, 60606, US

(73) Assignee: The Regents of the University of California

(21) Appl. No.: 11/635,289

(22) Filed: Dec. 7, 2006

Related U.S. Application Data
(60) Provisional application No. 60/754,922, filed on Dec. 29, 2005.

(51) Int. Cl. H04L 12/56

(52) U.S. Cl. 370/395.52; 709/200

(57) ABSTRACT

Methods, systems and devices for sharing communication resources among a plurality of clients and base-stations that are part of a common wireless community. The communication resources are, for example, Internet access resources. Another example, might be a video or data delivery communication resource. As an example, clients have separate Internet access accounts. Embodiments of the invention, for example, allow client business units or residential units to share separate Internet access accounts.

### PRIORITY CLAIM

Applicants claim priority benefits under 35 U.S.C. § 119 on the basis of Patent Application No. 60/754,922, filed Dec. 29, 2005.

### TECHNICAL FIELD

A field of the invention is network communications, including Internet and intranet communications. The invention concerns network access resource sharing among a plurality of clients within a common base-station aided wireless community network.

### BACKGROUND OF THE INVENTION

Dial-up service is a common method of Internet access. Dial-up service uses a dial-up modem through which a computer makes phone calls to an Internet service provider. The dial-up modem transforms digital data from the personal computer into an analog signal for transmission through a phone line, and conversely converts incoming analog signals into digital data for the personal computer. Dial-up service is known to be slow. For example, viewing web pages with multimedia content, such as graphical images, is often unacceptably slow.

Broadband access addresses this problem by providing higher digital data rates than dial-up service. A “DSL” (Digital Subscriber Line) involves upgrading the dial-up modem to a higher speed modem, known as a DSL modem, as well as using an upgraded modem device at the Internet Service Provider (ISP) premises, also known as the “central office.” The DSL approach uses existing copper wire, possibly upgraded along certain segments to increase its capacity to carry digitized information. Often the DSL access line is a spare telephone line that is already connected to the client location, such as a business or a residential unit, and the central office is owned and operated by the local telephone company. The data rates achievable by DSL are dependent on the distance between the client location and the central office, and range roughly between 100 kbps-1500 kbps. A DSL connection is commonly called a broadband access line. There are many client locations, e.g., residential units, that are too far away from a central office to have DSL service available.

Another broadband access scheme most commonly used with residential clients makes use of the coaxial cable that passes through a residential unit, for purposes of providing television signals to the home, “Cable TV”. A specialized modem, called a cable modem, is attached the coaxial cable inside the residential unit. The cable modem facilitates digital communication between the residential unit and facilities owned by the cable TV operator (often called a “Multiple Services Operator” (MSO)). The MSO is attached to the Internet, and thus becomes an Internet service provider for the residential unit. The coaxial cable entering a residential unit is typically shared with other residential units in close geographic proximity. Peak data rates on the order of approximately 2 million bits per second (Mbps) are possible with cable modems, with current service offerings.

A recent broadband access method utilizes a backhaul wired or wireless connection dedicated to a base-station to provide wireless Internet access to residential customers via the base-station. All traffic from and to the residential customers is routed to the Internet via this dedicated backhaul. The base-stations are deployed as standalone equipment, such as on top of a tall building, on top of a hill or on top of a lamp-post.

### SUMMARY OF INVENTION

Methods, systems and devices for sharing communication resources among a plurality of clients that are part of a common base-station aided wireless community. The wireless community includes a base-station that aids the resource sharing. The communication resources are, for example, Internet access resources. Another example, might be a video or data delivery communication resource. As an example, clients have separate Internet access accounts. Embodiments of the invention, for example, allow client business units or residential units to share separate Internet access accounts.

### BRIEF DESCRIPTION OF THE DRAWINGS

FIG. 1 is a block diagram of a residential broadband access system in accordance with an embodiment of the invention;

FIG. 2 is a block diagram of a residence or base station system for use with the residential broadband access system of FIG. 1.

### DETAILED DESCRIPTION

The invention concerns methods, systems and devices for sharing communication resources among a plurality of clients that are part of a common base-station aided wireless community. The communication resources are, for example, Internet access resources. Another example, might be a video or data delivery communication resource. As an example, clients have separate Internet access accounts. Embodiments of the invention, for example, allow client business units or residential units to share separate Internet access accounts.

The base-station aided wireless community network is used to share individual network access resources available at one or more of the clients. In preferred embodiments, the network access is Internet access, and one or more clients in a common base-station aided wireless community, e.g., a wireless area network such as an IEEE 802.11b network and non-residential base-station equipment, provides an Internet connection. Among the clients in the common base-station aided wireless community, there are likely to be a plurality of Internet connections, and, in preferred embodiments, the base-station equipment also provides an Internet connection. For example, in a particular base-station aided wireless community, there may be a number of clients with DSL connections, a number of clients with Cable connections, and a number of clients with slow dial-up connections and a base-station equipment with a broadband connection, e.g., a T1 connection. The combined resources are made available for network communications in clients in the base-station aided wireless community.

In preferred embodiments, clients in the base-station aided wireless community, for example through software or modems, are configured to act as a local proxy to facilitate a client's communication with a proxy server instead of network resource. In some cases, a proxy server may be implemented in a client device in the wireless community or server device placed in the wireless community or at the base-station equipment for the purpose of implementing a proxy server. In other cases, a proxy server may be accessed through the network, for example the Internet. In either case, based upon traffic patterns or other information about usage of the Internet connections in the base-station aided wireless community, the proxy protocol directs client packets to Internet connection resources available in the base-station aided wireless network such that some or all of the Internet connection resources are shared among clients in the base-station aided wireless community. The proxy server appends information necessary for packet routing to and from clients, and establishes a communication session with a network resource, e.g. a server on the Internet, on behalf of clients in the base-station aided wireless community.

Embodiments of the invention provide, for example, a shared access broadband access system serving a plurality of geographically co-located clients, e.g., residences. Individual clients in a base-station aided wireless community of clients have a wired network access line, which could be either a narrowband access line or a broadband access line. The access system exploits these network access line resources and the access line resources at the base-station equipment if the base-station is equipped with one, as well as a wireless communication medium that interconnects the clients and the base-station equipment. The wireless communication medium, for example a base-station aided wireless area network, facilitates the pooling together of the wired access lines, and clients connected to the base-station aided wireless area network then share the pooled access lines. Clients are thereby provided with an access medium that has a larger capacity to transport bursts of data than that provided by the wired access line of a single client. Clients in the wireless area network are provided with shared access broadband access, without requiring each residential unit to have a dedicated broadband access line. The performance of existing wired broadband access lines can also be significantly improved with this invention. In some embodiments, the base-station provides broadband access for use in the sharing used in the wireless community, while in other embodiments the base-station equipment has no access line, and simply aids establishing the wireless community.

In preferred embodiments of the invention, clients are residential units, such as houses or apartments. A high percentage of the units have a form of wired Internet access. In some preferred embodiments, each client has a wired Internet connection. However, methods and systems of the invention are fault tolerant to the loss of one or more client wired access connections. In some embodiments, a server may be part of the client wireless community, for example to act as a proxy server and/or provide a baseline level of wired network access by one or more broadband connections. This baseline connection to the wired network is then enhanced by client wired access resources when such resources are available through the base-station aided wireless community.

The wireless community may be established and exist through implementation, for example, of prevailing standards for wireless area networks. In a preferred embodiment, the wireless community is established in accordance with one of the standards of 802.11a, 802.11b, 802.11g or 802.16 (WiMax) or a combination thereof. More generally, the base-station aided wireless community may be implemented with any protocol that permits clients in the community to route packets from local proxies to a proxy server in or apart from the base-station aided wireless community. Clients are generally geographically located within the limits of the base-station aided wireless community. Thus, the wireless medium and protocol used to establish the wireless community defines the geographic boundaries of a client wireless community. Typically, and in preferred embodiments, this will be a close geographical arrangement, such as within a business park, in an office building or group of buildings with a number of business units (e.g., different firms or companies), or in neighborhood of residential units.

Embodiments of the invention include devices or software resident within or connected to a client and within or connected to the base-station equipment for providing Internet access within a client. The device or software implements a protocol to communicate with other like devices or software resident within or connected to other clients or base-stations that are part of a common base-station aided wireless community, where some of the other clients and, in some embodiments the base-station, have an Internet connection. The device or software is able to identify packets from different sessions, and can assign sessions to clients with an Internet connection. The software directs packets transmitted from clients over one or more Internet connections in the common base-station aided wireless community, and forwards packets received from an Internet connection and belonging to a session to the client with an Internet connection, using said protocol. In a preferred embodiment, an Internet connection to a client may be routed through the base-station equipment, which may or may not have an access line. In a preferred embodiment, the device or software is implemented in a DSL modem, and in other exemplary embodiments it is implemented in a wireless access point, a router, a switch, a cable modem, or a dial-up modem. The device or software can also be implemented at the base-station equipment. Encryption may be provided by the device or software to protect client sessions data from exposure to other clients in the base-station aided wireless community.

A preferred embodiment method for Internet access includes establishing a base-station aided wireless community of clients, for example with a wireless network protocol such as 802.11. At least some of the clients in the network of clients have an Internet connection. Packets generated by a client for Internet communications are identified as needing to be redirected through other clients in the base-station aided wireless community network in order to reach a destination server on the Internet. In a preferred embodiment, the redirection from a client to the other clients might be routed via the base-station equipment. For each packet identified as needing to be redirected, one of a plurality of client Internet connections is selected among the client Internet connections in the base-station aided wireless community. Each packet is then forwarded through the Internet connection selected for the packet. Packets received from a server available on the Internet are directed to an appropriate client in the base-station aided wireless community according to session information established on behalf of the client.

Preferred embodiments where clients are residential units will now be discussed, while artisans will appreciate broader aspects of the invention from their description. In addition, a residential unit may, for example, include multiple clients (e.g., multiple computers). For simplicity of explanation, in the example, each residential unit will be assumed to have a single client. A residential unit client may exploit the bursty nature of data traffic generated by residential Internet users. In particular, in a local neighborhood of residential units, it is unlikely that all residential unit clients are using their Internet access lines at the same time. The idle capacity of the access line of a residential unit client can be used to support the data transfer requests of an active user in another residential unit. A base-station aided wireless community, for example a wireless local area network, that interconnects the clients (individual computers, for example) in a local neighborhood, sometimes with and sometimes without the help of the base-station equipment, facilitates the sharing of the Internet access lines. All of the Internet access lines in a neighborhood network, including the Internet access line at base-station equipment if there exist an access line, are thus pooled together and shared, creating the capability for a residential unit client to avail itself of the transmission capacity in all Internet access lines of the base-station aided wireless community if no other residential unit has a need to transfer data at a given time. This will improve the speed of Internet access, for example web browsing, without requiring an upgrade of existing wired access lines to each residential unit, and thus provide for shared access broadband access at low cost. It also provides fault tolerance, as the failure of a particular residential unit client's Internet access line does not cause a road block to Internet access, and in a base-station aided wireless community with a fair amount of shared Internet access connections is unlikely to have a significant impact on bandwidth available for Internet access including access pressures caused by bursty traffic conditions. Exemplary embodiments of the invention, as applied to a single neighborhood of residential units each having a single client are referred to as an ISP-Unaware embodiment and a Meta-ISP embodiment. An embodiment that is a variation of the Meta-ISP embodiment and may be referred to as an ISP-aware embodiment will also be discussed briefly in the context of the Meta-ISP embodiment.

The embodiments to be discussed leverage a TCP session protocol for the directing of packets to and from clients in a base-station aided wireless community. There are many existing session-oriented protocols in use in the Internet, such as TCP and RTP, and the embodiments discussed below can operate with any such session-oriented protocol.

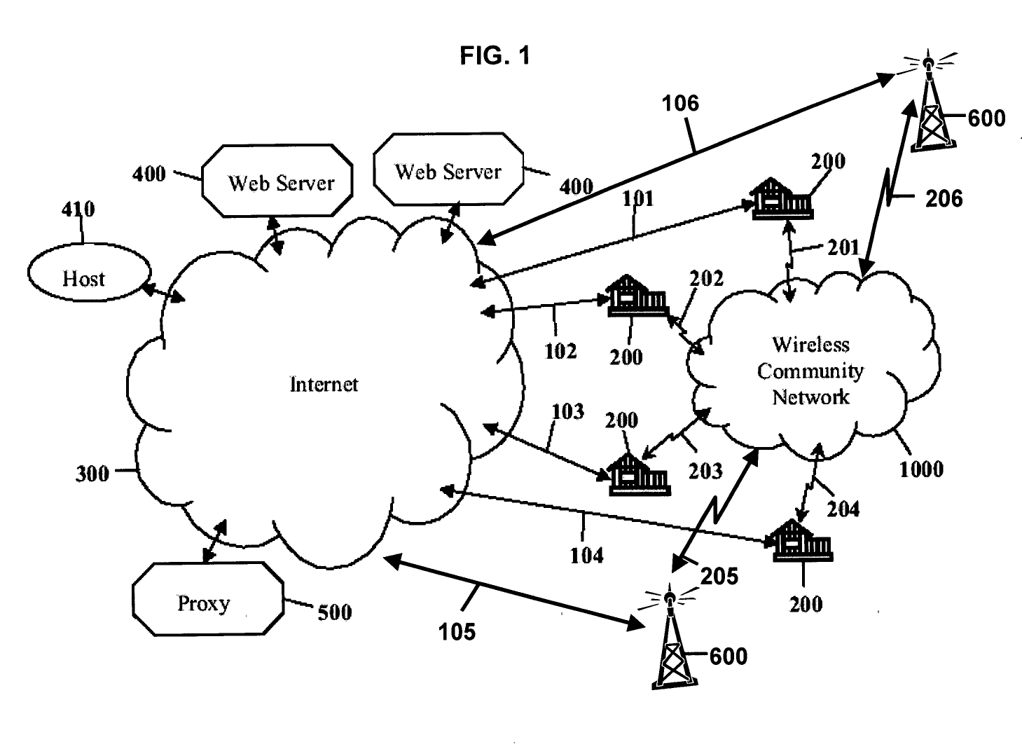

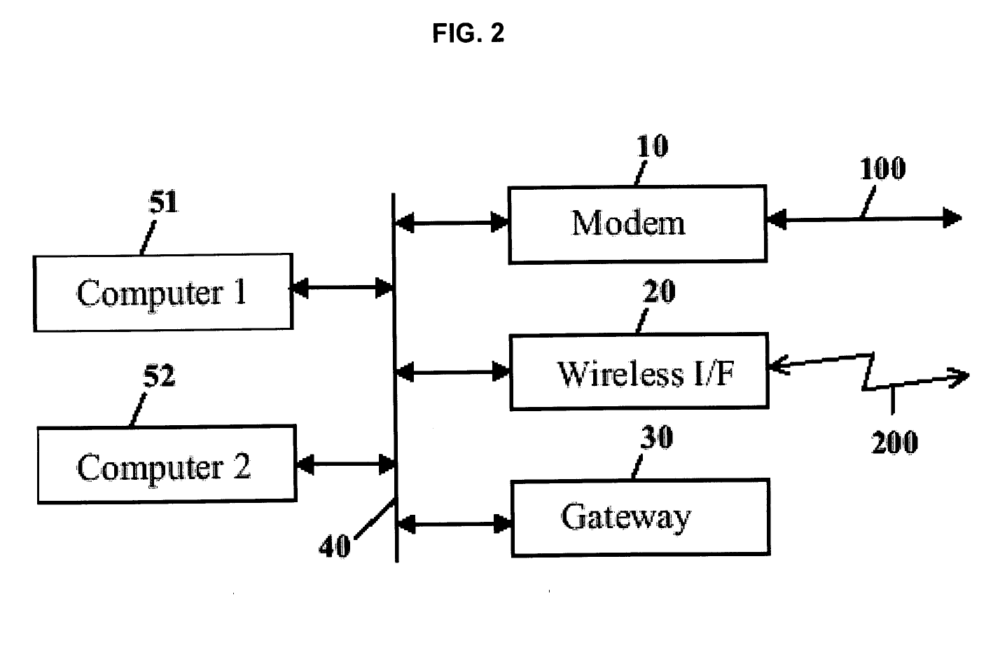

Operation of the preferred embodiments will be discussed with respect to an exemplary embodiment residential broadband access system that is shown in FIGS. 1 and 2, where base-stations aid the wireless community communications and also provide an additional Internet access line to the wireless community. In FIG. 1, the access system has a plurality of residential Internet access lines 101 to 104 and also includes base-station access lines 105 to 106 with a wireless community 1000 formed by a wireless communication medium and protocol 200 (a set of radio frequency channels, for example) and base station 206, 205 protocol(s). The internet access lines in the FIG. 1 embodiment are within respective residential units 200 of the wireless community 1000, and connect to the Internet 300. The internet access lines in the FIG. 1 embodiment are within respective base-stations 600 of the wireless community 1000, and connect to the Internet 300. Also shown are a couple of web servers 400 that client computers in the residential units 200 and base-stations 600 may communicate with through the Internet access lines 101 to 104 and 105 to 106 and the Internet 300. For discussing implementation of a meta-ISP embodiment, a proxy server 500 is shown as connected to the Internet for access by proxy servers within the residential units 200 and base-stations 600.

An exemplary residential unit 200 is illustrated in FIG. 2. A residential unit may contain one or more personal computers 51, 52, interconnected by a Local Area Network (LAN) 40. A modem 10 provides for communication on a residential access line 100. For example, the residential access line could be a regular telephone line, or a DSL line, and the modem 10 would then be either a dial-up modem or a DSL modem. If the residential access line represents a coaxial cable that also delivers television signals, the modem 10 would be a cable modem. A wireless communication interface 20 conducts communications with the other residential units as well as the base-stations in the base-station aided wireless community over a wireless channel or channels 201-204 that follow a protocol, e.g. IEEE 802.11. The interface 20 may be a Wireless LAN access point, for example. A collection of wireless interfaces implements the wireless community 1000 illustrated in FIG. 1. A gateway 30 controls how the wireless network 1000 is used to enhance the utility of the residential access lines 101-104 and the base-station access lines 601-602. The gateway 30 could be a stand-alone hardware device, or could be implemented in software and integrated with the wireless interface 20. Alternatively, a software implementation of a gateway could reside on one of the computers 51 or 52. Indeed, as will be clear to those skilled in the art, the modem 10, wireless interface 20, and the gateway 30 can be integrated into one of the computers 51 or 52.

A residential unit 200 can represent a house or a unit in an apartment or condominium complex. However, as has been discussed above, the invention also applies to other clients, such as places of business that use dial-up lines, DSL, or cable modems for access to the Internet.

A base-station unit is quite similar to a residential unit in terms of abstract functions, and can also be illustrated as in FIG. 2. The wireless interface 20 can be segmented into sectors served by different antenna elements, as artisans will appreciate. The wireless interface 20 can use a standard wireless communication protocol, such as IEEE 802.11a, 802.11b. 802.11g, or 802.16 (WiMax), for example. The modem 10, if present, provides a backhaul link to the Internet 300, and can be implemented either with wireless or wired communication links. For example, the modem 10 could be implemented with a DSL link, a T1 link, or a WiMax link, for example.

The web servers 400 and the host 410 represent devices that computers inside residential units 200 and the base-station equipment units 600 communicate with. For example, when a user browses the web on a computer, web pages are displayed. The web pages contain objects that reside on web servers 400. As another example, a user inside a residential unit may wish to transfer a computer file to or from a remote host 410. The wireless community network (WCN) 1000 is thus used to enhance the performance of the residential access lines 101-104 and base-station equipment access lines 105-106. In additional embodiments, a substitute medium and protocol is used in place of the wireless communication medium. Example substitute mediums include communications over power lines, high-speed communication over twisted-pair copper (HomePNA3.0) or using line-of-sight optical links or a combination thereof. “HomePlug” and “HomePNA” are evolving industry standards (see the Homeplug and HomePNA web sites, which are available at the “org” extension), and it provides substitute mediums and protocols for forming a base-station aided client community in additional preferred embodiments.

ISP-Unaware

In the ISP-Unaware embodiment, traffic is split across the access lines of the base-station aided wireless community 1000 formed in a residential neighborhood at the granularity of a TCP session. A wireless communication medium and protocol (e.g., IEEE802.11 a/b/g, IEEE802.16 or a combination thereof) interconnects gateway devices 30 installed in each residential unit and base-station equipment to form the base-station aided wireless community 1000. The gateway device 30 can be implemented in software inside a user's personal computer, by a separate hardware device, or embedded into a wireless local area network (WLAN) access point, for example. Each gateway device 30 can act as proxy, and all of the proxies in the base-station aided wireless community 1000 coordinate to share the access lines 101-104 of clients and the access lines 105-106 of the base-station equipment 600 that are part of the base-station aided wireless community 1000.

A request made from a client computer inside a residential unit 200 to initiate a TCP session with a device outside the base-station aided wireless community, e.g. one of the web servers 400, is redirected by the gateway device 30 acting as a local proxy within the same residential unit to a remote proxy (another gateway device) that resides in another one of the residential units 200, through the wireless communication medium 200 and protocol or in one of the base-station equipment units 600, through the wireless communication medium 200 and protocol. The remote proxy then makes TCP session requests on behalf of the client computer that originally made the TCP session request. After the session is initiated, data packets from the session that originate at the device outside the base-station aided wireless community are then transported to the remote proxy. The remote proxy then forwards these data packets via the wireless medium and protocol to the local proxy, which in turn forwards the packets to the client computer that originally initiated the session.

Similarly, after the session is initiated, data packets originating at the client computer that initiated the TCP session are redirected by the local proxy to the remote proxy via the wireless communication medium and protocol. In turn, the remote proxy forwards these session data packets to the device outside the wireless community, e.g., one of the web servers 400, that was the original target of the TCP session request. The gateway devices 30 act as a network of proxies in the neighborhood that performs a load balancing function, attempting to spread the TCP session requests from all residential units so that traffic is divided evenly across all of the access lines 101-104 in the residential units 200 and access lines 104-105 in the base-station equipment units 600 of the wireless community. Packets originating from a client computer inside a residential unit that are not recognized as belonging to a session are transported through the Internet access line that terminates at the residential unit, and thus do not need to be transported via the base-station aided wireless communication network.

Although the ISP-Unaware embodiment offers a potentially dramatic improvement in performance relative to when no sharing of access lines is used, there are two limitations. First, the granularity at which traffic is split across all of the access lines can be rather large because the amount of data transported for each TCP session can be large and unpredictable, thus limiting the capability to reliably spread load evenly across residential access lines and base-station access lines. Second, traffic traveling between the Internet and a single residential unit may pass through other residential units, raising privacy concerns. To partially address this concern, the proxies may utilize encryption in their joint communications as a way to provide security for communications of clients with respect to other clients and base-stations in the base-station aided wireless community. This only partially addresses the privacy concern, since the data that flows across the Internet access resources is often not encrypted at a remote server, and thus is potentially visible in the clear at a plurality of residential units.

Data transfers in packet networks are often facilitated by session-oriented protocols. In particular, to realize communication between two endpoints, a session may first be initiated, whereby both endpoints communicate initially to synchronize state information for functions such as flow control and error control. This initial communication often takes the form of what is called a three-way handshake. Once both endpoints have synchronized state information, the flow of data can then take place. The transfer of session data packets realizes such data flow. Each session data packet is labeled with an identifier that determines the identity of the session. This identifier is typically determined during the initial state synchronization. Once the data transfer is completed, the end points then exchange control messages to terminate the session.

A TCP session, for example, is identified by an IP address and a port number associated with each endpoint. To initiate a session, TCP uses a three-way handshake, whereby special control packets called SYN packets are exchanged, which determine initial sequence numbers used for error recovery and flow control.

Consider a data transfer between a computer 51 and a web server 400 using a session-oriented protocol, which is initiated by the computer 51. With the present invention, such a session may be altered, without modification of the protocols at the endpoints. In particular, the gateway device 30 attached to the local computer 51 acts as a proxy to facilitate the data transfer, as has been discussed generally above. Another proxy, referred to as the remote proxy, also facilitates the data transfer. The remote proxy resides on the gateway device within another residential unit or base-station unit belonging to the same base-station aided wireless community network 1000. The invention alters the session in the following way. When the local computer 51 first initiates a communication with the web server 400, the local proxy residing inside the local gateway device 30 intercepts the packets associated with this communication and determines that a session initiation is taking place. The local proxy acts in accordance with how the web server would act, hence the name proxy. In particular, instead of the session taking place between the local computer 51 and the web server 400, the session takes place between the local computer 51 and the local proxy 30. In order to facilitate the data transfer, the local proxy selects another proxy, called a remote proxy. The remote proxy resides in the gateway device 30 inside another residential unit or in a base-station equipment unit belonging to the same base-station aided wireless community network 1000. The selection of the residential unit or base-station that contains the remote proxy, among all of the residential units 200 and base-stations 600 belonging to the base-station aided wireless community network 1000, can be made on the basis of the state of the wireless community network 1000, past selection decisions, as well as on the basis of the pattern of recent activity on the residential access lines 101-104. For example, the proxies may exchange state information on the wireless community network and the residential access lines and base-station access lines, and use this state information to form the basis for a selection decision. In an exemplary embodiment, a round robin approach is used for selection, and this and other scheduling algorithms may be used.

After local proxy implemented by a gateway 30 intercepts the packet associated with the session initiation by the local computer 51, the local proxy initiates a session with the remote proxy implemented by another gateway device in the base-station aided wireless community network 1000. This session takes place via the wireless community medium and protocol 200 if the remote proxy resides in a residential unit; and takes place via the wireless community medium and protocol 600 if the remote proxy resides in a base-station equipment unit. In turn, if the remote proxy is in a residential unit, the remote proxy initiates a session with the web server 400, via the residential access line (one of the Internet access lines 101-104) attached to the remote proxy; if on the other-hand the remote proxy is in a base-station equipment unit, the remote proxy initiates a session with the web server 400, either via its own access line 105-106 or via a remote residential access line by making use of the base-station aided wireless community network 1000. In effect, the remote proxy communicates directly with the web server 400 instead of the local computer 51.

The remote proxy forwards session data packets from the web server 400 to the local proxy 30 via the base-station aided wireless community network 1000, which in turn forwards the session data packets to the local computer 51. Similarly, in the other direction, the local proxy 30 forwards session data packets from the local computer 51 to the remote proxy via the base-station aided wireless community network 1000, which in turn forwards the session data packets to the web server 400.

Artisans will note that the local and remote proxy need not independently generate protocol messages on behalf of the represented entity, and that the session between a local and remote proxy can be virtual. Rather, the local and remote proxies can simply forward session packets after applying an address translation.

Artisans will also note that the remote proxy function is supported on existing networking appliances without any modification. In particular, commercially available wireless access points (e.g. IEEE 802.11b/g/a-WiFi) commonly perform a Network Address Translation (NAT) function, in order to map local IP addresses to a single IP address. Thus, from the viewpoint of a local proxy, a standard wireless access point with the NAT function can be used as a remote proxy. In this case, the wireless access point might be within a residential unit that does not have a local proxy present, and in this case the sharing of internet access resources might look unilateral at first, but if the shared internet resources are made available to that resident owning the wireless access point via the base-station aided wireless community network, the sharing of internet access resources will become reciprocal. Artisans will also note that gateway devices may include memory for temporarily storing packets, for example to implement re-ordering and other functions.

Since some applications and protocols are not session oriented, the local proxy 30 may intercept packets from the local computer 51 which it does not recognize as belonging to any session. In this case the local proxy 30 simply forwards such packets to attached residential access line 100 via the modem 10. Such packets are not transported across the wireless community to another proxy for implementing resource sharing.

Meta-ISP (and ISP Aware)

The Meta-ISP embodiment is similar to the ISP-Unaware embodiment, except that each gateway device 30 acts only as a local proxy. Instead of remote proxies being located at residential units 200 and base-station equipment units 600 throughout the base-station aided wireless community 1000, a dedicated proxy server 500 acts as proxy server for all residential units 200 and base-stations 600. This proxy server and can be located within or outside the neighborhood, and within or outside the local-ISPs that terminate the residential access lines. In an example embodiment, the proxy server 500 is accessible through the Internet.

A request made from a client computer, e.g., 51, 52 within the base-station aided wireless community 1000 to initiate a TCP session with a device, e.g., one of the web servers 400, outside the base-station aided wireless community is redirected by the gateway 30 implementing a local proxy within the same residential unit to the proxy server 500. The proxy server 500 then makes TCP session requests on behalf of the client computer that originally made the TCP session request. After the session is initiated, data packets from the session that originate at the web server 400 are then transported to the proxy server 500. The proxy server 500 then forwards these data packets to the local proxy implemented by a gateway device, which in turn forwards the packets to the client computer that originally initiated the session. Similarly, after the session is initiated, data packets originating at the client computer that initiated the TCP session are redirected by the local proxy to the proxy server 500. In turn, the proxy server 500 forwards these session data packets to the web server that was the original target of the TCP session request.

The communication between a gateway device 30 implementing a local proxy function and the proxy server 500 can take place by using any of a plurality of Internet access lines in residential units and base-stations that are within the base-station aided wireless community, making use of the wireless communication medium and protocol that interconnects the residential units and base-station equipment units. Traffic can be divided across these residential access lines and base-station access lines at the granularity of a packet, and thus the load can be evenly spread across the access lines. The decision process for each packet that determines which access line will be used to transport the packet can be based on the state of the base-station aided wireless network, the past history of decisions for other packets, as well as the current state of the access lines. The network of local proxies may exchange state information to facilitate this decision process. For example, the local proxies can use such state information to estimate the total load placed on each access line, and attempt to distribute load evenly among the access lines. The local proxies and the proxy server 500 can also implement packet reordering, to increase the chances that packets will be transported end-to-end in the same order they were originally sent. The packet reordering can be implemented with sequence numbers that are inserted into the packets traveling between the proxy server 500 and the local proxies. In addition, the local proxies and proxy server can provide encryption and decryption to each packet that travels between them, thereby alleviating the privacy concerns discussed earlier. In particular, data flowing across residential access lines and base-station access lines as well as between residential units is encrypted, making Internet communications less susceptible to eavesdropping by neighbors. Packets originating from a computer inside a residential unit that are not recognized as belonging to a session are transported through the residential access line that terminates at the residential unit, and thus do not need to be transported via the base-station aided wireless communication network.

The Meta-ISP embodiment does not require cooperation from a local-ISP that terminates one or more of the residential access lines 101-104. The proxy server 500 may be separate from any local-ISP. However, if all the residential access lines 101-104 are terminated by the same local-ISP, and the local-ISP wishes to cooperate with the sharing of residential access lines pursuant to the invention, then the proxy server can be operated by the local-ISP. This is an ISP-aware variation of the Meta-ISP embodiment.

An example communication will be discussed with respect to the system shown in FIGS. 1 and 2. Consider a data transfer between a computer 51 and a web server 400 using a session-oriented protocol, which is initiated by the computer 51. Such a session may be altered, without modification of the protocols at the endpoints. In particular, the gateway device 30 attached to the local computer 51 acts as a local proxy to facilitate the data transfer. When the local computer 51 first initiates communication with the web server 400, the local proxy intercepts the packets associated with this communication and determines that a session initiation is taking place. The local proxy acts in accordance with how the web server 400 would act. In particular, instead of the session taking place between the local computer 51 and the web server 400, the session takes place between the local computer 51 and the local proxy 30. To facilitate the data transfer, the local proxy 30 communicates with the proxy server 500. The proxy server 500 initiates a session with the web server 400. In effect, the proxy server 500 communicates directly with the web server 400 instead of the local computer 51.

The proxy server 500 forwards session data packets from the web server 4001 to the local proxy 30, which in turn forwards the session data packets to the local computer 51. Similarly, in the other direction, the local proxy 30 forwards session data packets from the local computer 51 to the proxy server 500, which in turn forwards the session data packets to the web server 400.

To facilitate communication between the local proxy 30 and the proxy server 500, any of the residential access lines 101-104 or the base-station access line 105-106 may be used, making use of the base-station aided wireless community network 1000. The selection of which access line to use for a particular packet can be made on the basis of the state of the base-station aided wireless community network 1000 or the pattern of recent traffic on the access lines 101-104 and 105-106, for example. Once the selection is made, the packet can be forwarded accordingly. For example, for a packet received from the web server 400, the proxy server 500 can prepend a label to the packet that specifies the gateway device within the residential unit that terminates the selected residential access line. This label can be inserted into the destination address field of a packet whose payload is the packet that is to be transported, for example. The proxy server 500 then forwards the packet to the gateway device associated with the selected residential access line. Upon receiving the packet, the gateway device then strips the label prepended by the proxy server 500 off of the packet. The packet is then forwarded through the wireless interface associated with the gateway device, and delivered to the local proxy via the base-station aided wireless community network 1000.

For a packet from a local proxy to the proxy server 500, this process is simply reversed. In particular, a residential access line 101-104 or a base-station access line 105-106 is selected as before. The local proxy 30 forwards the packet to the wireless interface 20 for delivery through the base-station aided wireless community network 1000 to the gateway device associated with the selected access line, which in turn forwards the packet to the proxy server 500 via the selected access line. The packet is appropriately pre-pended with labels to facilitate forwarding the packet in the manner just described, as will be clear to those skilled in the art. The local proxy and the proxy server 500 can periodically communicate to facilitate the selection of appropriate access lines, and therefore spread the traffic load across the access lines, in both directions.

In addition, packets sent from the proxy server 500 to the local proxies may be labeled with sequence numbers. The local proxies can use the sequence numbers to determine the order in which they were sent by the proxy server 500, and delay packets appropriately so that they are forwarded to the local computer 51 in the same order that they were sent by the proxy server 500. This packet reordering feature may improve the performance of data transfers substantially, due to the fact that many session-oriented protocols assume that the underlying network usually delivers packets in the same order in which they are sent.

In the reverse direction, packets sent from the local proxy 30 to the proxy server 500 may be labeled with sequence numbers. The proxy server 500 can use the sequence numbers to determine the order in which they were sent by the local proxy 30, and delay packets appropriately so that they are forwarded to the web server 400 in the same order that they were sent by the local computer 51.

To provide privacy, the proxy server 500 may encrypt packets that are sent to a local proxy via the wireless medium and protocol 200. When the packets reach the local proxy 30, the local proxy may decrypt the packets before forwarding them to the local computer 51. In the reverse direction, the local proxy 30 may encrypt the packets that are sent to the proxy server 500. When the packets reach the proxy server 500, the proxy server may decrypt the packets before forwarding them to the web server 400. A degree of privacy is thus achieved between the residential units, since the packets traveling between the residential units 200 as well as through the residential access lines and base-station access lines are encrypted.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claim

1. A method for providing shared communication resource access, the method comprising steps of:
establishing a network of clients, wherein at least a plurality of the clients in the network of clients have a their own associated communication resource connection;
providing the network of clients with access to a base-station that aides in communications among the clients;
providing a communication protocol between the network of clients and the base-station;
providing a protocol for sharing the communication resource connections of the at least some of the clients to the network of clients with the aid of the base-station; and
spreading communications, with aid of the base-station, from a client in the network of clients among the communication resource connections of the at least a plurality of the clients in the network.

2. The method of claim 1, wherein the communication protocol between the network comprises a wireless protocol that is implemented via a wireless medium.

3. The method of claim 1, wherein the base station provides an additional communication resource connection.
